(19) United States
(12) Patent Application Publication
(10) Pub. No.: US 2022/0070411 A1
(43) Pub. Date: Mar. 3, 2022

(54) SYSTEM FOR CREATING VIRTUAL ENVIRONMENTS FOR VIRTUAL EVENTS

(71) Applicants: Shu Li, Irvine, CA (US); Xiping Wu, Irvine, CA (US)

(72) Inventors: Shu Li, Irvine, CA (US); Xiping Wu, Irvine, CA (US)

(73) Assignee: J&J Investments Worldwide, Ltd., Irvine, CA (US)

(21) Appl. No.: 17/006,852

(22) Filed: Aug. 30, 2020

(51) Int. Cl. H04N 7/15; H04N 7/14; H04S 7/00

(52) U.S. Cl. CPC H04N 7/157; H04S 2400/11; H04S 7/303; H04N 7/142

(57) ABSTRACT

A system for creating virtual environments for virtual events is disclosed. The system allows the user to create any event in a virtual environment. The system comprises a computing device, a database in communication with the computing device, and one or more user devices with camera in communication with the computing device. The computing device comprises a processor and a memory in communication with the processor, wherein the memory stores a set of instructions executable by the processor. The user devices communicate the computing device via a network using an application software or mobile application or web-based application executed in a computer-implemented environment or network environment. Each user device is configured to create and/or access the virtual events. The computing device is configured to communicate one or more virtual attendees present in their physical location and virtually put the attendees in their virtual space in the virtual event.

### BACKGROUND OF THE INVENTION

### A. Technical Field

The present invention generally relates to virtual environments, and more specifically relates to a system for generating and maintaining virtual environments for virtual events such as, but not limited to, basketball event, board meeting, wedding, movie theater, family room meeting, dinner, etc. via a software application.

### B. Description of Related Art

A virtual environment is a networked application that allows a user to interact with both the computing environment and the work of other users. Virtual Event planning is a web-based event planning service that is now-a-days in trend and an effective way of executing events in time and cost-effective way. The major advantage of the virtual event planning is that the virtual events can easily be customized and visualized with the selected list of contributors and participants over the Internet, both in real-time and on-demand. Virtual event platforms have become a common method for creating and providing interactive content, in the form of customized virtual events, to a large audience over the Internet, both in real-time and on-demand.

Few existing patent references related to the above-discussed problem are discussed as follows:

WO2015148789 of Howard L. SIEGEL et. al. entitled “generating and maintaining a virtual environment for virtual sports” discloses a method for generating and maintaining an interactive environment for a virtual sports event. A sports event comprises a sports league and/or a sports game. A user acts as the owner or general manager of his/her virtual team, for example, a user creates his/her team by drafting computer generated virtual representations of real-life athletes. Virtual teams compete against each other based on real-life sporting event data. Users are able to create customized virtual rooms where they conduct the drafting of the players and the trading of the players. A virtual currency balance is also displayed. Virtual currency can be awarded to users based on participation in various games hosted by the virtual environment. A plurality of user systems and server systems communicatively coupled to at least one network, information processing systems such as desktop computers, portable computing devices such as laptop computers, mobile/smart phones, tablet computing devices, wearable computing devices (e.g., smart watches, bands, etc.). The users can also communicate with each other via video, audio.

US20170365102 assigned to Huston Charles D., disclose about a system and method for creating a 3D virtual model of an event, such as a wedding or sporting event, and for sharing the event with one or more virtual attendees. The virtual attendees can see and interact with other virtual attendees in the virtual gallery. The event has also created a companion augmented reality application that helps integrate these virtual attendees into the trade show, allowing them to engage with actual event participants, presenters, objects in the booth, and exhibitors. A port device allows a mobile device to synchronize with a host device using one or more protocols. Images and audio are captured using camera systems and used to create a live, 3D, photo-realistic environment from which remote attendees can virtually walk and participate in the trade show. However, the above-discussed references do not allow the system and method to automatically adjust the seeing angle when each person facing their own camera directly in the virtual space.

Therefore, there is a need for a system for generating and maintaining virtual environments for virtual events such as, but not limited to, basketball event, board meeting, wedding, movie theater, family room meeting, dinner, etc. via a software application. Further, there is also a need for a system that automatically adjusts the seeing angle when each person facing their own camera directly in the virtual space, for example, if a person looks left and right, he may see the side view of the people next to him as opposed to all face to face.

### SUMMARY OF THE INVENTION

The present invention discloses a system for generating and maintaining virtual environments for virtual events such as, but not limited to, basketball event, board meeting, wedding, movie theater, family room meeting, dinner, etc. via a software application.

In one embodiment, the system is configured to allow a host or an organizing user to create any event in a virtual environment. In one embodiment, the organizing user could custom arrange the virtual environment based on their requirement, for example, table quality and quantity, size, wall decoration, wall logo, etc. The system comprises one or more user devices, wherein each user device is associated with the user including the organizing user and one or more virtual attendees. The system further comprises a network and a virtual event management system. In one embodiment, the user device is enabled to access the virtual event management system via the network. In one embodiment, each user device comprises an image capturing device or camera or virtual machine to capture the image or video in the virtual event. In one embodiment, the user device is at least any one of a smartphone, a mobile phone, a tablet, a laptop, a desktop, and/or other suitable handheld electronic communication devices. In one embodiment, the user device comprises a storage medium in communication with the network to access the virtual management system.

In one embodiment, the virtual management system comprises a computing device and a database in communication with the computing device. In one embodiment, the database is accessible by the computing device. In another embodiment, the database is integrated into the computing device or separate from it. In some embodiments, the database resides in a connected server or a cloud computing service. Regardless of location, the database comprises a memory to store and organize certain data for use by the computing device.

In one embodiment, the virtual management system comprises a computing device and a database in communication with the computing device. In one embodiment, the computing device could be a cloud server. In one embodiment, the computing device comprises a processor and a memory unit in communication with the processor. The memory unit stores a set of instructions executable by the processor to host the virtual event. In one embodiment, the user devices are configured to access the services provided by the computing device via the network.

In one embodiment, the user device is configured to connect to the computing device via the network using an application software or mobile application or web-based application executed in a computer-implemented environment or network environment. The application software allows a host or an organizing user to host any virtual event in the virtual environment via online. In one embodiment, the user turn-on the camera to view themselves and other attendees sitting next to them or watching in front of them in the virtual environment. The camera is configured to make adjustments to enable the user to see other users in the virtual space while facing their own camera. In one embodiment, the application software automatically adjusts the viewing angle of the user in the virtual environment.

In one embodiment, the remote attendees attend the virtual event via their local video camera of the user device. The application software places each attendee into respective location in the virtual space. In one embodiment, the attendees get on the camera of the user device in their home and they are placed on the virtual environment as avatars. The avatars are gathered to socialize in the virtual space where the virtual event is performed by the application software and provides audio with distance-based three-dimensional sound effects to make the attendees feel like real-world event.

In one embodiment, the computing device further comprises a virtual production facility module. In one embodiment, the virtual production facility module configured to provide virtual effects to the user in the virtual meeting by placing the user spatially inside the virtual environment, thereby making the user to feel that the user is in a real event, for example, making the user to feel that the user is sitting at a table next to other people as opposed to be from a distance. In one embodiment, the virtual production facility module is further configured to provide sound effect that collect all sounds from each attendee's video and weigh them based on the spatial distance from the user attending the virtual event.

In one embodiment, the computing device further comprises an interactional module. In one embodiment, the interactional module is configured to establish a connection between the user device of the host or event planner and the participants or attendees. In one embodiment, the interactional module makes a front face video into a three-dimensional video by taking recordings in all directions such as side-way, back-way, etc. Depending on the relative view angle in relative locations, the application software automatically adjusts and corrects the angle from the particular viewer. In one embodiment, the application software automatically adjusts to the correct angle from the particular viewer, despite the attendees transmitting only front looking videos. In one embodiment, the event place could be customized to any setting and any size of the crowd.

In one embodiment, the user is able to create a customized virtual room/event with any number of crowd and size. In one embodiment, the system requires a high-speed network connectivity for video streaming in large virtual events. Further, the computing device is configured to provide communication between the attendees in the form of chat, audio, video, and text connectivity.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 exemplarily illustrates a computer-implemented system implemented in an environment for creating virtual environments for virtual events, according to an embodiment of the present invention.

FIG. 2 exemplarily illustrates a components and connection between the components of a computing device, according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

As will be appreciated by one skilled in the art, aspects of the embodiments may be embodied as a device, system, method or program product. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These codes may be provided to a processor or other programmable data processing apparatus to produce a machine, such that the instructions, which execute via the processor or other programmable data processing apparatus, create means for implementing the functions/acts specified in the schematic flowchart diagrams and/or schematic block diagrams block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

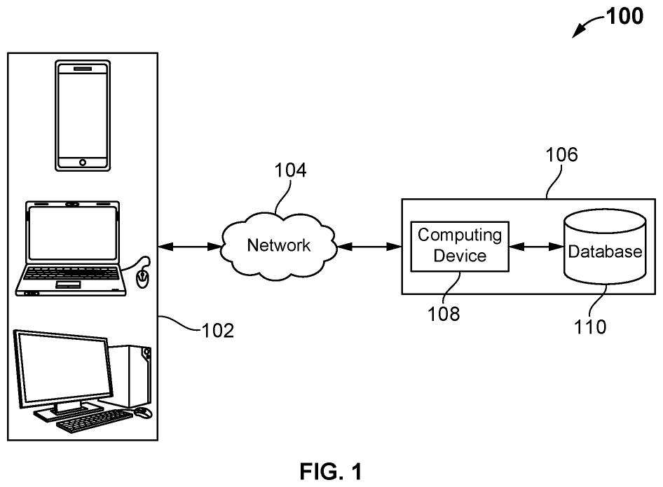

FIG. 1 exemplarily illustrates a computer-implemented system implemented in an environment 100 for creating virtual environments for virtual events, according to an embodiment of the present invention. In one embodiment, the system runs in a three-dimensional virtual environment for generating and maintaining the virtual events. In one embodiment, the system is an application software or web-based application or mobile application or desktop application. The application software allows a host or an organizing user to host any virtual event in the virtual environment via online. In one embodiment, the organizing user could custom arrange the virtual environment based on their requirement, for example, table quality and quantity, size, wall decoration, wall logo, etc. In some embodiments, the virtual event could be NBA basketball event, board meeting, wedding, movie theater, family room meeting, dinner, etc. In one embodiment, the user/host and a plurality of attendees could participate in the virtual meeting.

In one embodiment, the computer-implemented environment 100 comprises one or more user devices 102, wherein each user device 102 is associated with a user including the organizing user and one or more virtual attendees. Each user device 102 is associated with the user configured to create and/or access the virtual event. The system further comprises a network 104 and a virtual event management system 106. In one embodiment, the user device 102 is enabled to access the virtual event management system 106 via the network 104. In one embodiment, each user device 102 comprises an image capturing device or camera or virtual machine to capture the image or video in virtual event. In one embodiment, the user device 102 is at least any one of a smartphone, a mobile phone, a tablet, a laptop, a desktop, and/or other suitable handheld electronic communication devices. In one embodiment, the user device 102 comprises a storage medium in communication with the network to access the virtual management system 106. In an embodiment, the network 104 could be Wi-Fi, WiMAX, wireless local area network (WLAN), satellite networks, cellular networks, private networks, and the like.

In one embodiment, the virtual management system 106 comprises a computing device 108 and a database 110 in communication with the computing device 108. In one embodiment, the database 110 is accessible by the computing device 108. In another embodiment, the database 110 is integrated into the computing device 108 or separate from it. In some embodiments, the database 110 resides in a connected server or in a cloud computing service. Regardless of location, the database 110 comprises a memory to store and organize certain data for use by the computing device 108.

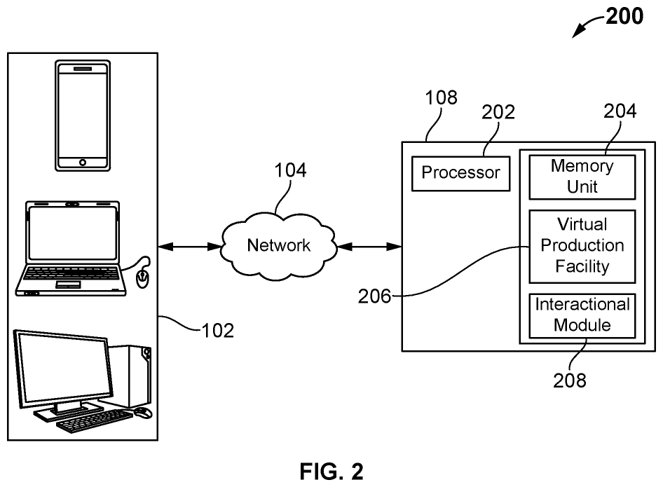

Referring to FIG. 2, a block diagram 200 of the components and connection between the components of the virtual management system 106, according to an embodiment of the present invention. In one embodiment, the virtual management system 106 comprises a computing device 108 and a database 110 in communication with the computing device 108. In one embodiment, the computing device 108 could be a cloud server. The server is configured to collect one or more parameters from the user device 102. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of an application software, a mobile application, a browser, an OS, and/or any combination thereof.

In one embodiment, the computing device 108 comprises a processor 202 and a memory unit 204 in communication with the processor 202. The memory unit 204 stores a set of instructions executable by the processor 202 to host the virtual event. The memory unit 204 could be RAM, ROM (including EPROM, EEPROM, PROM). In one embodiment, the user devices 102 are configured to access the services provided by the computing device 108 via the network 104. In one embodiment, the computing device 108 is configured to provide communication between the attendees in the form of chat, audio, video, and text connectivity.

In one embodiment, the user device 102 is configured to connect to the computing device 108 via the network 104 using an application software or mobile application or web-based application executed in a computer-implemented environment or network environment. In one embodiment, the user turn-on the camera to view themselves and other attendees sitting next to them or watching in front of them in the virtual environment. The camera is configured to make adjustments to enable the user to see other attendees in the virtual space while facing their own camera. In one embodiment, the application software automatically adjusts the viewing angle of the user in the virtual environment.

In one embodiment, the remote attendees attend the virtual event via their local video camera of the user device. The application software places each attendee into respective location in the virtual space. In one embodiment, the attendees get on the camera of the user device in their home and they are placed on the virtual environment as avatars. The avatars are gathered in the virtual space to socialize where the virtual event is performed by the application software and provides audio with distance-based three-dimensional sound effects to make the attendees feel like real-world event.

In one embodiment, the computing device 108 further comprises a virtual production facility or virtual production facility module 206. In one embodiment, the virtual production facility module 206 configured to provide virtual effects to the user in the virtual meeting by placing the user spatially inside the virtual environment, thereby making the user feel that the user is in a real event, for example, making the user feel that the user is sitting at a table next to other people as opposed to being from a distance. In one embodiment, the virtual production facility module 206 is further configured to provide a sound effect that collects all sounds from each attendee's video and weigh them based on the spatial distance from the user attending the virtual event.

In one embodiment, the virtual production facility module 206 is configured to create/generate a customized virtual environment of any virtual event, for example, a sports stadium with all the seats, stairways, etc. of various kinds, a board room custom decorated with an Albany table, leather chair, company logo, etc., and a wedding place decorated with hotel lobby, ocean-side, etc. For example, if person-A has a date to meet person-B in B's living room (the virtual space), person-B custom chooses a virtual space with ocean view, art display, and Italian furniture sets. The person-A gets on the camera at A's home, but virtually placed onto B's virtual place's sofa, and the two chat in virtual reality while each drinking their own coffee.

In one embodiment, the user and the attendees/participants could attend the virtual event from their physical location. In one embodiment, the computing device 108 further comprises an interactional module 208. In one embodiment, the interactional module 208 is configured to establish a connection between the user device 102 of the host or event planner and the participants. In one embodiment, the interactional module 208 makes a front face video into a three-dimensional video by taking recordings in all directions such as side-way, back-way, etc. Depending on the relative view angle in relative locations, the application software automatically adjusts and corrects the angle from the particular viewer. In one embodiment, the application software automatically adjusts to the correct angle from the particular viewer, despite the attendees transmitting only front looking videos.

In one embodiment, the virtual production facility module 206 provides the production of the virtual event either fully or partially, for example, virtually displaying event on a real location, a computer-generated location, a camera-captured location, or a live stage with the potentially unlimited audience following on their electronic devices. In one embodiment, the event place could be customized to any setting and any size of the crowd. In one embodiment, the user is able to create a customized virtual room/event with any number of crowd and size. In one embodiment, the size of the attendee and the voice in the virtual space could be automatically adjusted based on the viewing location and perspective viewing angle so that farer the viewer, smaller the size of the attendee and lower the voice.

In one embodiment, the virtual environment could be a sports stadium with all the seats, stairways, etc. of various kinds. The application software allows the attendees to participate in the virtual sports environment by placing them in the virtual space. If a person who attends a basketball game will dress like going to the real games, act like in the real game, drink, shot, cheer as they wish in front of their camera in their living room. The application software virtually puts the attendee into a virtual stadium seat in a video live. In one embodiment, the attendees could turn the camera to themselves to see themselves and other audience “sitting” next to them in the stadium or watching in front of him the entire stadium. In one embodiment, the attendee could also hear the collective sounds of all the people and the stadium as people from everywhere virtually cheer and do whatever on their virtual seat.

In another embodiment, the virtual environment could be a meeting room. The application allows the attendees to participate in the virtual meeting environment by placing them in the virtual space. For example, 8 people attend a board meeting virtually from each of their home offices. Each of them virtually sits on one of the chairs around the board table in the virtual space in a conference room. In one embodiment, the camera emulator could automatically adjust the viewing angle so that the attendee could see a person from their side even though the attendee is facing their own camera.

In yet another embodiment, the virtual environment could be a function hall. The application allows the attendees to participate in the virtual function environment. For example, 100 people attending a wedding, each of them is dressed formally and walking around in their own home. In one embodiment, the application places the attendees together into the virtual space such as the wedding hall to socialize, until the wedding host call everyone's attention to have the ceremony. Also, people could hear the collective background noise very similar to a real situation.

During virtual events, many videos steam together at the same time. In one embodiment, the application software requires a high-speed network connectivity such as 5G for large virtual events. In the virtual space, each attendee faces their own camera directly. In one embodiment, the application software could automatically adjust the viewing angle. For example, if a person looks left and right, the person could see the side view of the people next to him as opposed to all face to face. In one embodiment, the virtual effects in the application software let the person be spatially inside. For example, if the person is virtually sitting at a table, the person needs to feel next to other people as opposed to being from a distance. In one embodiment, the sound effect in the application software needs to take into all sounds from each attendee's video but weigh them based on the spatial distance from the person who attends the virtual event. In one embodiment, the distance-based 3D sound and a 360° environment with the real-time 3D voice could make the user freely move and interact like a real-world event.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system for creating and maintaining an interactive environment for virtual events, comprising:
a computing device having a processor and a memory in communication with the processor, wherein the memory stores a set of instructions executable by the processor;
a database in communication with the computing device, and
one or more user device with a camera in communication with the computing device via a network, wherein each user device is associated with a user configured to create and/or access the virtual event,
wherein the computing device is configured to communicate one or more virtual attendees present in a physical location via the user device and virtually put the attendees in their virtual space in the virtual event.

2. The system of claim 1, wherein the user device is configured to connect to the computing device via the network using an application software or mobile application or web-based application executed in a computer-implemented environment or network environment.

3. The system of claim 1, is configured to allow the user to create any event in a virtual environment.

4. The system of claim 1, wherein the user turn-on the camera to view themselves and other attendees sitting next to them or watching in front of them in the virtual environment.

5. The system of claim 1, wherein the camera is configured to make adjustments to enable the user to see other users in the virtual space while facing their own camera.

6. The system of claim 1, wherein the application software automatically adjusts the viewing angle of the user in the virtual environment.

7. The system of claim 1, wherein the attendees attend the virtual event via their local video camera and the application software places each attendee into respective location in the virtual space.

8. The system of claim 1, wherein the users/attendees get on the camera of the user device in their home and they are placed on the virtual environment as avatars.

9. The system of claim 1, wherein the avatars are gathered in the virtual space to socialize where the virtual event is performed by the application software and provides audio with distance-based three-dimensional sound effects to make the attendees feel like a real-world event.

10. The system of claim 1, wherein the application software automatically adjusts and corrects the viewing angle from a particular attendee depending on the relative view angle in relative locations.

11. The system of claim 1, further comprises a virtual production facility module configured to provide virtual effects to the user in the virtual meeting by placing the user spatially inside a virtual environment, thereby making the user to feel that the user is sitting at a table next to other people as opposed to be from a distance.

12. The system of claim 1, wherein the virtual production facility module further configured to provide a sound effect that collects all sounds from each attendee's video and weighs them based on the spatial distance from the user attending the virtual event.

13. The system of claim 1, wherein the user is able to create a customized virtual room/event with any number of crowd and size.

14. The system of claim 1, requires a high-speed network connectivity for video streaming in large virtual events.

15. The system of claim 1, wherein the computing device is configured to provide communication between the attendees in the form of chat, audio, video, and text connectivity.

16. The system of claim 1, wherein the user device is at least any one of a smartphone, a mobile phone, a tablet, a laptop, a desktop, and other suitable handheld electronic communication devices.
